(19) United States
(12) Patent Application Publication
(10) Pub. No.: US 2009/0046364 A1
(43) Pub. Date: Feb. 19, 2009

(54) Dust Barrier For DSLR Camera

(76) Inventor: Ross Wordhouse, Bend, OR (US)

Correspondence Address: PERKINS COIE LLP, P.O. BOX 1208, SEATTLE, WA, 98111-1208, US

(21) Appl. No.: 11/838,851

(22) Filed: Aug. 14, 2007

(51) Int. Cl. G02B 27/00

(52) U.S. Cl. 359/507

(57) ABSTRACT

A polymer dust barrier device for protecting digital single lens reflex (DSLR) camera sensor filters from foreign particulates which includes an optical quality polymer and double sided removable adhesive tape. The user would remove their lens from their DSLR camera and insert a uniquely shaped polymer dust barrier over the camera internal chamber. An island set removable adhesive would hold the dust barrier in place and will protect the camera chamber and sensor filter from external particulates while the user is changing lenses or exposes the internal chamber to the external environment.

### BACKGROUND OF THE INVENTION

This invention relates to digital single lens reflex (DSLR) cameras. More specifically this invention relates to the blocking of foreign particles that can accumulate on the internal imaging sensor filter found within a DSLR camera. The teaching of the present invention enables retrofitting and protection of current and future models of DSLR camera chambers and sensor filters from dust and foreign particles.

### DESCRIPTION OF THE PRIOR ART

DSLR camera sensor filters are continually being contaminated by foreign particles which ruin the quality of the image being taken by the photographer. The main contamination comes from the exterior environment when a photographer changes lenses and exposes the camera chamber to the elements, thus exposing the sensor filter to particulates. Another small contamination point is within the camera chamber itself. When the reflex mirror moves to expose the sensor to capture an image it disturbs the air and any particulates contained within the chamber.

In patent application US 2007/0035656 there is reference to a dust barrier that is built into the camera and sealed to the outside environment. The sealed dust barrier will deflect outside particulates but it can also cause internal pressure within the camera body due to the seal. It requires a vent hole to help release the pressure that might arise from changes in altitude. It also does not address the internal chamber issue due to the sealed dust barrier not being able to be removed to extract the internal accumulation of dust particulates.

In patent application US 2006/0188248 there is a reference to a dust barrier that is built into the camera and is made of glass. This dust barrier can be removed to access internal dust particulates. This patent, nor the previous patent, does not address how to protect and deflect foreign particulates for the 13 million DSLR camera's already in the camera market place. They both have dust barriers that must be designed and built into new DSLR cameras, thus excluding a very large portion of the camera industry.

An alternative dust barrier solution that can be retro fitted to current and future models of DSLR camera's is made of an optical quality polymer that is extremely thin and can be shaped to protect and cover any current or future DSLR camera chambers. The optical polymer is held in place with removable tape and is adhered to the exposed surfaces that form the top chamber walls of the camera. It can be removed easily to clean any internal dust that might form on the sensor filter within the camera chamber. The thickness of the polymer is very thin and optically clear in order to not obstruct the functionality of the lens or DSLR camera.

### SUMMARY OF THE INVENTION

The present invention teaches a variety of systems, methods and devices for limiting foreign particles within cameras. One embodiment teaches a polymer dust barrier device for limiting foreign particles from a sensor filter found within the internal workings of a functioning DSLR camera. Certain aspects of the present invention include the combination of two elements, the optical quality polymer and the strategically located double-sided removable tape. This combination creates an easy to install dust barrier device for the protection of the sensor filter and camera chamber from exterior foreign particles. According to another aspect of the present invention, the shape and thickness of the polymer dust barrier mimics the contours of current camera chambers in such a way that the polymer does not interfere with the camera and/or lens functionality. Yet another aspect of the present invention teaches that the polymer dust barrier can be removed to access and clean particulates that might form from internal moving parts of the camera. A still further aspect of the present invention teaches that the polymer dust barrier can be designed and manufactured to fit any current or future DSLR camera that does not offer a dust barrier device. Some embodiments of the present invention provide for easy installation by the operator of the DSLR camera.

An alternative feature is the ability to design and manufacture the polymer dust barrier for the exterior rear element chamber ring of a lens to prevent dust from adhering to the rear element of the lens.

### DESCRIPTION OF THE DRAWINGS

FIG. 1 is a top view of the polymer dust barrier with double sided tape.

FIG. 2 is a top view of the dust barrier with a protective plastic on its top and adhered to a release liner.

FIG. 3 is a line up of all the parts of the polymer dust barrier.

FIG. 4 is side view of the lamination order of all the parts.

FIG. 5 is a front view of a DSLR camera with the dust barrier in place.

FIG. 6 is a cross section a DSLR camera with a dust barrier being put into place.

FIG. 7 is a cross section of a lens with the dust barrier installed on the rear exposed chamber walls of the lens.

### DRAWING REFERENCE NUMERALS

1 Polymer Dust Barrier
2 Double Sided Removable Adhesive Tape
3 Protective Electrostatic Plastic with Pull Tab
4 Release Liner
5 DSLR Camera
6 Camera Lens Mount
7 Exposed Camera Chamber Top
8 Foam Cushion for Mirror
9 Mirror
10 Lens and Camera Electrical Interface
11 Camera Chamber Wall
12 Sensor Filter
13 Sensor
14 Lens
15 Optical Element
16 Lens Chamber Wall
17 Lens Mount
18 Exterior Side of Lens
19 Exposed Lens Chamber Top

### DESCRIPTION OF THE PREFERRED EMBODIMENT

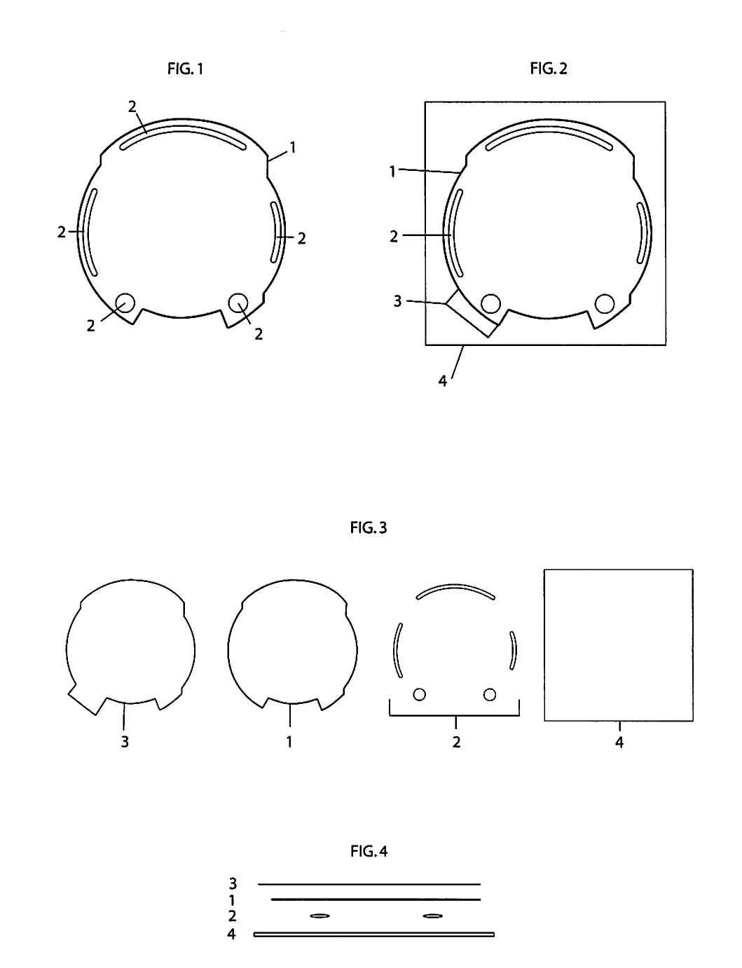

The polymer dust barrier includes two main elements as shown in FIG. 1, the optical quality polymer 1 and the double sided removable tape 2. In an exemplary embodiment, the optical quality polymer 1 has about a 92% light transmission so affects to the captured image will be negligible. As will be appreciated, other implementations can have various light transmission effects. The thickness of the optical polymer could be in the range of 0.2 mm or less in order to not affect the camera and lens functionality when in place, although any suitable thickness depending upon the specific application is allowable. The optical polymer can be shaped in multiple ways for multiple cameras in order to fit precisely within the confines of a DSLR camera chamber.

The polymer can be coated with various optical enhancing features if desired, such as anti-static coating, anti-glare coating, neutral density coating, UV coating or the like. The light transmission, thickness, shape and coatings can very depending on end needs. The double sided removable adhesive tape 2 has a strong adhesive on one side and a medium tack removable adhesive on the other. The strong side faces the optical polymer and the medium tack removable side is exposed for adhesion to the camera. The tape is die cut and strategically placed on the back of the optical polymer 1 in order to adhere to the camera's exposed chamber top but not obstruct the image to be captured.

The polymer dust barrier FIG. 1 can be seen in FIG. 2 with the addition of a release liner 4 and a protective static plastic cover which has a pull tab 3. The release liner 4 gives the dust barrier strength during transport and it also give the medium tack adhesive 2 something to adhere to. The protective plastic cover 3 keeps the optical polymer from being scratched and the tab allows for its easy removal.

FIG. 3 and FIG. 4 show different exploded views of all the laminated pieces of the protected polymer dust barrier. A first layer is the protective static plastic 3 which is cut when the optical polymer 1 is die/laser cut and shaped. The island set double sided removable adhesive 2 is placed on the back of the optical polymer 1 and then placed upon the release liner 4. Those skilled in the art of converting will see that there are no special features in this lamination technique.

An alternative to this manufacturing would be to design them for the rear elements for camera lenses. The manufacturing would remain the same, only the size and shape would change in order to fit a specific lens. As will be appreciated, a variety of other manufacturing techniques could be used and fall within the spirit of the present invention.

### OPERATION OF THE INVENTION

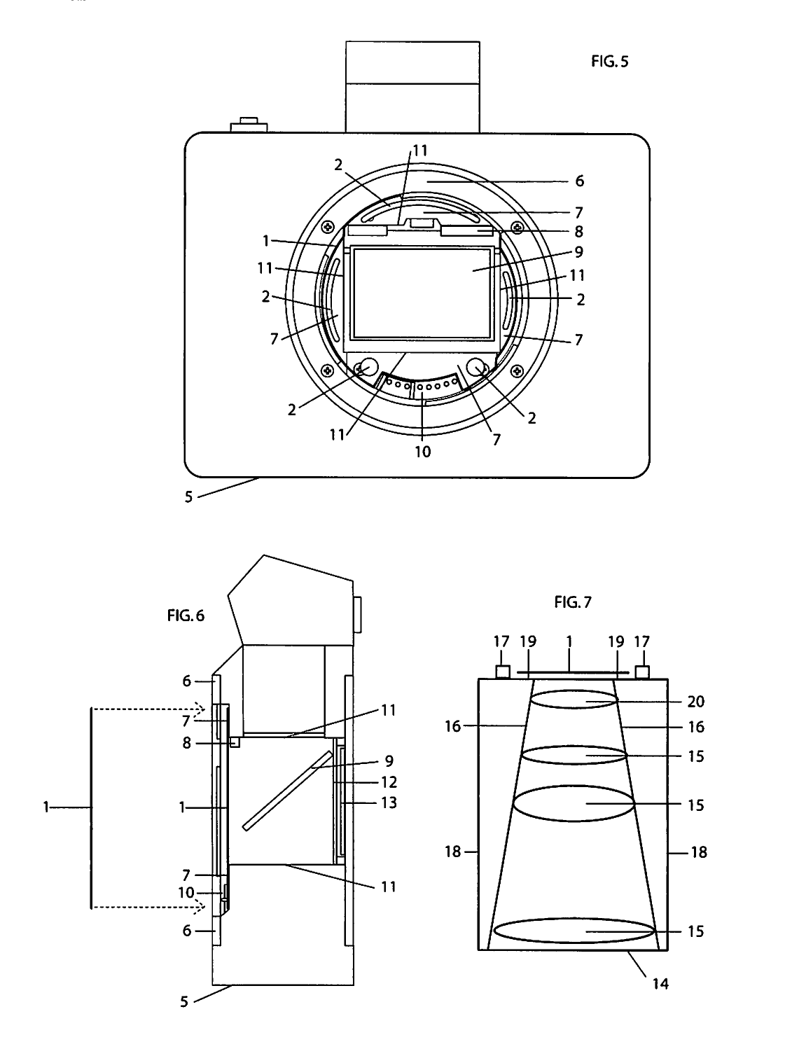

According to one aspect of the present invention, the user would remove their lens and expose their DSLR camera chamber FIG. 5 and reveal the inner workings of their camera 5. The user would then grab the protective plastic tab 3 of the protected dust barrier FIG. 2 and remove the dust barrier from its release liner 4. The user would then align the shape of the dust barrier 1 with the shape of the exposed camera chamber top 7. Then the user would descend the dust barrier 1 into place and affix the adhesive on the back of the dust barrier to the exterior chamber walls 7. The dust barrier 1 would cover all the chamber walls 11 that run perpendicular to the chamber top 7. The dust barrier 1 also rests atop the foam pads 8 and does not interfere with their operation when the camera mirror 9 is triggered. Once it is on place then the user would pull the protective plastic tab 3 and expose the optical polymer 1. They would then replace their lens back onto the camera 5. In FIG. 6 we can see a side view of the insertion of the dust barrier 1 onto the exposed camera chamber walls 7. This view shows how the dust barrier 1 can protect the mirror 9, the sensor filter 12, the sensor 13 and the chamber walls 11 from exterior particulates when a lens is changed on the camera 5.

An alternative to this operation can be seen in FIG. 7 with the dust barriers 1 use on a lens 14. The user would go through all the same steps of previous application but would be applying the specially shaped dust barrier 1 for that specific lens 14. They would apply the dust barrier 1 to the exposed rear chamber top 19 that surrounds the rear element 20 of the lens 14. This would protect the lens chamber walls 16 and the rear element 20 from being exposed to particulates.

While these and other features of the invention have been described by reference to the preferred embodiments, those skilled in the art will recognize that the invention can be varied in manufacturing, arrangement and detail without departing from the scope of the invention.

1. A polymer dust barrier for protecting a digital single lens reflex camera sensor filter and chamber comprising: an optical quality plastic film; a protective electrostatic plastic with a pull tab statically adhered to an upper surface of the optical quality film; a first adhesive member having a first upper adhesive surface, and a second lower adhesive surface having a lesser adhesion strength than the first upper adhesive surface; a first adhesive member being bonded to a lower surface of the optical quality plastic film; and a second lower adhesive removably adhered to a protective release liner.

2. A polymer dust barrier for protecting a digital single lens reflex camera sensor filter and chamber according to claim 1 wherein the optical plastic film has a light transmission greater than about 90% and may be coated with various properties to enhance performance.

3. A polymer dust barrier for protecting a digital single lens reflex camera sensor filter and chamber according to claim 1 wherein the optical plastic is 0.5 mm thick or thinner.

4. A polymer dust barrier for protecting a digital single lens reflex camera sensor filter and chamber according to claim 1 wherein the optical plastic has an enhancing optical coating.

5. A polymer dust barrier for protecting a digital single lens reflex camera sensor filter and chamber according to claim 1 wherein the optical plastic is shaped to not interfere with current and future DSLR camera models and lens operations while covering the cameras chamber opening.

6. A polymer dust barrier for protecting a digital single lens reflex camera sensor filter and chamber according to claim 1 wherein the optical plastic can be retro fitted, shaped and sized to any current or future DSLR camera chamber that does not offer this functionality.

7. A polymer dust barrier for protecting a digital single lens reflex camera sensor filter and chamber according to claim 1 wherein the first adhesive member's lower adhesive surface is removable when applied to a cameras exposed chamber top.

8. A polymer dust barrier for protecting a digital single lens reflex camera sensor filter and chamber according to claim 1 wherein the first adhesive member is an island set on the optical plastic lower surface and strategically placed not to obstruct camera functionality.

9. A polymer dust barrier for protecting a lens rear element and chamber comprising: an optical quality plastic film; a protective electrostatic plastic with a pull tab statically adhered to an upper surface of the optical quality film; a first adhesive member having a first upper adhesive surface, and a second lower adhesive surface having a lesser adhesion strength than the first upper adhesive surface; a first adhesive member being bonded to a lower surface of the optical quality plastic film; and a second lower adhesive removably adhered to a protective release liner.

10. A polymer dust barrier for protecting a lens rear element and chamber according to claim 9 wherein the optical plastic film has a light transmission greater than about 90% and may be coated with various properties to enhance performance.

11. A polymer dust barrier for protecting a lens rear element and chamber according to claim 9 wherein the optical plastic is less than or about 0.5 mm thick.

12. A polymer dust barrier for protecting a lens rear element and chamber according to claim 9 wherein the optical plastic has an enhancing optical coating.

13. A polymer dust barrier for protecting a lens rear element and chamber according to claim 9 wherein the optical plastic is shaped to not interfere with current and future DSLR camera models and lens operations while covering the lens chamber opening.

14. A polymer dust barrier for protecting a lens rear element and chamber according to claim 9 wherein the first adhesive member's lower adhesive surface is removable when applied to an exposed lens rear chamber top.

15. A polymer dust barrier for protecting a lens rear element and chamber according to claim 9 wherein the first adhesive member is island set on the optical plastic lower surface and strategically placed not to obstruct lens functionality.
